(19) United States
(12) Patent Application Publication
(10) Pub. No.: US 2026/0110308 A1
(43) Pub. Date: Apr. 23, 2026

(54) Turbocharger housing and turbocharger

(71) Applicants: Grzegor Rzepka, Rzeszow (PL); Stefan Krell, Kaiserslautern (DE)

(72) Inventors: Grzegor Rzepka, Rzeszow (PL); Stefan Krell, Kaiserslautern (DE)

(73) Assignee: BorgWarner Inc., Auburn Hills, MI (US)

(21) Appl. No.: 19/285,046

(22) Filed: Jul. 30, 2025

(30) Foreign Application Priority Data
Jul. 31, 2024 (DE) 102024121817.7

(51) Int. Cl. F04D 29/46; F04D 17/10; F04D 25/02; F04D 29/046; F04D 29/58

(52) U.S. Cl. CPC F04D 29/464; F04D 17/10; F04D 25/024; F04D 29/046; F04D 29/582; F05D 2220/40; F05D 2240/14

(57) ABSTRACT

A turbocharger housing for a turbine (1) having a variable turbine geometry which can be adjusted by a control shaft (23), including
a turbine housing (3),
a bearing housing (9) having a longitudinal axis (33) and having a VTG bushing (25) for the control shaft (23), wherein the VTG bushing (25) is spaced apart from the longitudinal axis (33),
   wherein the bearing housing (9) includes a coolant jacket (27) which includes an inlet (29) and an outlet (31), wherein the coolant jacket (27) encloses the VTG bushing (25).

The invention relates to a turbocharger housing and to a turbocharger having such a turbocharger housing.

The use of turbochargers serves to increase the efficiency of internal combustion engines. Such an exhaust-gas turbocharger is responsible for pumping compressed air into the internal combustion engine. A compressor of the exhaust-gas turbocharger is driven by an exhaust-gas-driven turbine. The rotation of a turbine wheel caused by the exhaust gases of the internal combustion engine is transmitted via a shaft to a compressor wheel, as a result of which the air is compressed and pumped. The internal combustion engine in conjunction with the exhaust-gas turbocharger can be used in vehicles, for example in a passenger car. Turbochargers can also be used in conjunction with fuel cells.

A turbocharger housing comprises a turbine housing for the turbine wheel, a compressor housing for the compressor wheel, and a bearing housing for the shaft. The bearing housing connects the turbine housing and the compressor housing. A conventional bearing housing can be manufactured from grey cast iron.

It is possible to increase the efficiency and the power of the internal combustion engine by increasing the temperature of the exhaust gas which drives the turbine of the turbocharger. However, this leads to an increase in the thermomechanical stress on the bearing housing due to the simultaneous increase in the heat energy supplied with the exhaust gas.

A coolant jacket, also called cooling jacket or jacket cooling system, can be integrated in the bearing housing in order to allow the temperature to be lowered. Nevertheless, the residual loading can still exceed the strength of grey cast iron, leading to the formation of cracks on a turbine-side flange of the bearing housing. Such cracks can lead to leaks.

A turbocharger having a variable turbine geometry (VTG) comprises adjustable guide vanes, which are located in the turbine housing between a volute and the turbine wheel. The guide vanes influence the gas flow to the turbine wheel. A variable turbine geometry assembly comprises the guide vanes, which are coupled to a control shaft in such a way that a rotational movement of the control shaft brings about a pivoting movement of the guide vanes and, as a result, influences the gas flow to the turbine wheel.

In the case of a conventional turbocharger having a variable turbine geometry, a VTG bushing, through which the control shaft extends, is arranged in the bearing housing and located outside the region cooled by the coolant jacket. Therefore, the non-cooled region is exposed to considerable thermomechanical loading, which can lead to the formation of cracks in the vicinity of the bushing. In spite of the coolant jacket, most cracks occur in the region of the VTG bushing in a conventional bearing housing.

The problem addressed by the invention is that of relieving the stresses and consequently preventing the formation of cracks.

The problem is solved by a turbocharger housing and a turbocharger having the features of the independent claims.

A turbocharger housing for a turbine having a variable turbine geometry which can be adjusted by a control shaft comprises a turbine housing and a bearing housing, which has a longitudinal axis and comprises a VTG bushing for the control shaft. The VTG bushing is spaced apart from the longitudinal axis. The bearing housing comprises a coolant jacket which comprises an inlet and an outlet, wherein the coolant jacket encloses the VTG bushing.

The cooling-water jacket is formed by a cavity in the wall of the bearing housing, whilst the inlet and the outlet are openings on the outer side of the bearing housing. The cooling water flows from the inlet to the outlet through the above-mentioned cavity. The encircling cavity encloses the VTG bushing, as a result of which this region is cooled.

The coolant jacket enclosing the VTG bushing enables improved cooling in the region of the VTG bushing. This has the result that cracks, which could otherwise lead to a breakage, are prevented in this region where cracks occur most often in the case of a conventional construction. Consequently, more demanding applications can be created without needing to change the material of the components or to provide additional components. The housing material used can furthermore be grey cast iron. The complexity and costs are not significantly higher than for a conventional construction.

Nevertheless, minor modifications to the VTG kinematics, to the VTG bushing and to a control shaft assembly may be required. Since the VTG bushing is surrounded by a coolant jacket which requires additional space in the bearing housing, the VTG bushing may be longer than a conventional VTG bushing. Therefore, the mounting of the control shaft assembly in the bearing housing may be more complicated, particularly in cases in which a back plate is integrated in the bearing housing.

The turbocharger having such a turbocharger housing comprises a turbine housing, a turbine wheel arranged in the turbine housing, and a variable turbine geometry assembly which can be adjusted by a control shaft. A bearing housing has a longitudinal axis and comprises a VTG bushing through which the control shaft extends. The VTG bushing is spaced apart from the longitudinal axis. The bearing housing comprises a coolant jacket which has an inlet and an outlet, wherein the coolant jacket encloses the VTG bushing.

The variable turbine geometry assembly comprises a plurality of pivotable guide vanes, which are coupled to the control shaft in such a way that a rotational movement of the control shaft is transformed into a pivoting movement of the guide vanes and thus adjusts the plurality of guide vanes. In other words: rotating the control shaft brings about the adjustment of a plurality of guide vanes. The adjustment of the guide vanes influences an exhaust-gas flow to the turbine wheel. In one embodiment, the control shaft projects out of the bearing housing.

The bearing housing and the turbine housing are connected to one another. The longitudinal axis corresponds to the axis of rotation of the turbine wheel and of the shaft.

The coolant jacket is formed by a cavity in the wall of the bearing housing. The cooling water flows through the inlet into the cooling jacket and through the outlet out of the cooling jacket. In one embodiment, the coolant jacket encirclingly encloses the longitudinal axis and the VTG bushing.

In one embodiment of the turbocharger housing or of the turbocharger, the coolant jacket comprises a central flow path between the longitudinal axis and the VTG bushing. A shaft extends through the bearing housing of the turbocharger along the longitudinal axis, wherein the shaft is connected to the turbine wheel. In comparison to a conventional coolant jacket, a further arm is provided around the VTG bushing. The coolant jacket opens out into three paths, namely into the central flow path and two peripheral flow paths, which are subsequently merged again. The peripheral flow paths run around the sides of the longitudinal axis and of the VTG bushing which face away from the central flow path. Consequently, the longitudinal axis and the VTG bushing are encirclingly enclosed by the flow paths.

In one embodiment, a cross section of the coolant jacket perpendicular to the longitudinal axis comprises an outer contour line with a radial widening which encloses the VTG bushing. In addition, there is a first inner contour line which surrounds the longitudinal axis and a second inner contour line which encloses the VTG bushing. This configuration provides a widened cooling region which encloses the region of the VTG bushing.

In one embodiment, the outer contour line is a continuous curve having a circular basic shape and a bell-like radial widening. In addition or as an alternative thereto, the second inner contour line is a circular line. The ring-like basic shape corresponds to a flange which forms the turbine side of the bearing housing. Furthermore, the bell-like radial widening integrates the region of the VTG bushing in the cooling region.

In one embodiment, the central flow path between the longitudinal axis and the VTG bushing extends further in the axial direction with respect to the turbine housing than a peripheral flow path, which runs around the VTG bushing in the radial widening. This ensures good cooling of the central region. The flatter peripheral flow path at the periphery of the VTG bushing constitutes a good compromise between sufficient cooling and compact size.

In one embodiment, the longitudinal axis and the VTG bushing are arranged parallel to one another or at an acute angle relative to one another. This configuration allows the VTG assembly to be actuated from the lower side of the turbine.

In one embodiment, the turbine housing comprises a volute for inflowing gas, comprising an inlet portion and a tongue which defines the end portion of the volute, said end portion adjoining the inlet portion. The radial widening is oriented onto the inlet portion or the tongue. Consequently, the widened cooling region around the VTG bushing is oriented onto the part of the turbine that is exposed to a high heat loading by the inflowing hot gas. In order to achieve a compact design, the control shaft is arranged below the inlet portion or the tongue.

The turbocharger above can be used in conjunction with an internal combustion engine or a fuel cell.

In the figures, components that are identical or have the same effect are provided with the same reference signs. In the figures:

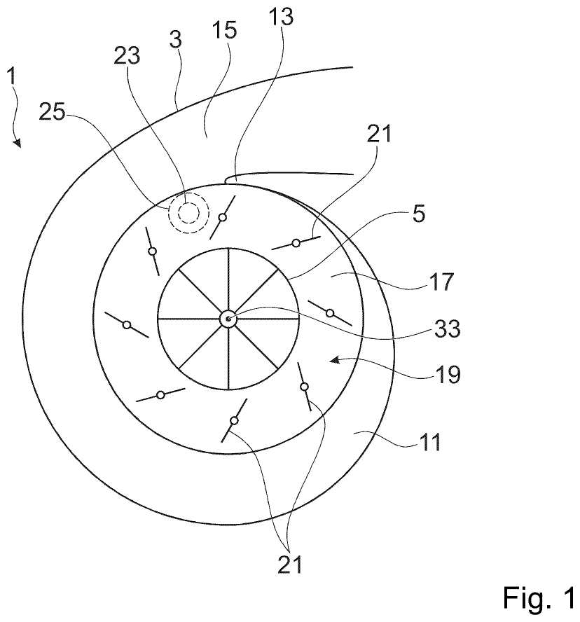

FIG. 1 shows a schematic illustration of one exemplary embodiment of a turbine having a variable turbine geometry,

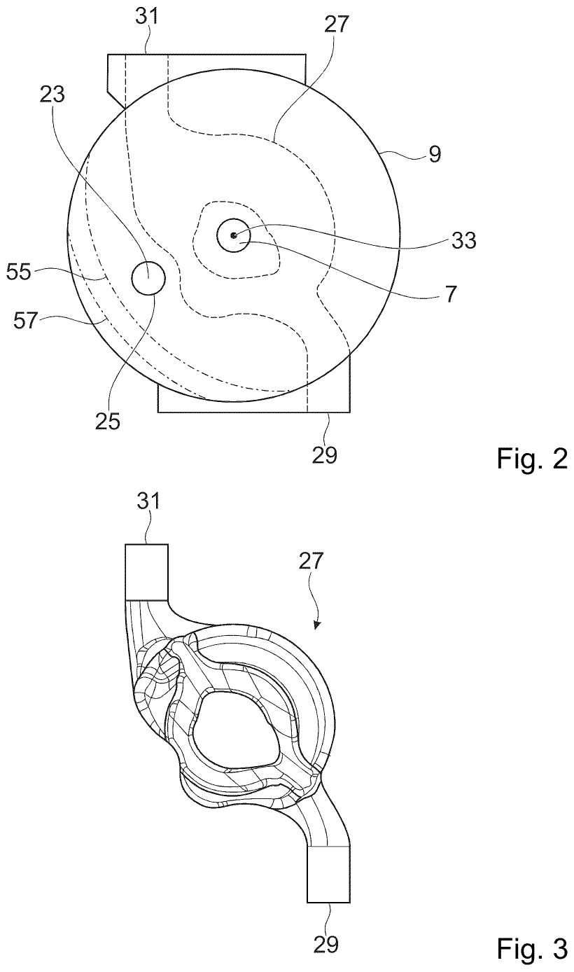

FIG. 2 shows a schematic illustration of one exemplary embodiment of a conventional bearing housing,

FIG. 3 shows an illustration of one exemplary embodiment of a conventional coolant jacket,

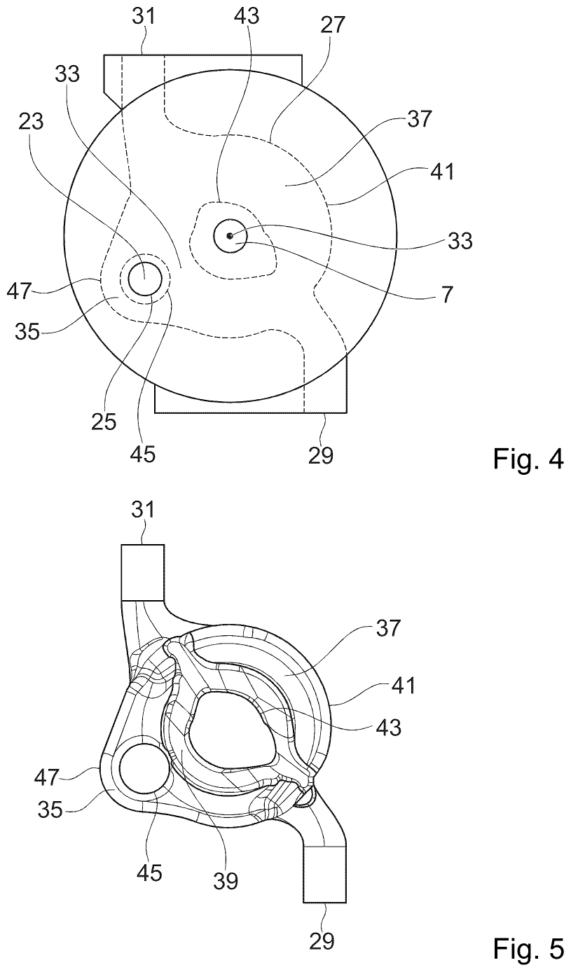

FIG. 4 shows a schematic illustration of one exemplary embodiment of a bearing housing,

FIG. 5 shows an illustration of one exemplary embodiment of a coolant jacket, and

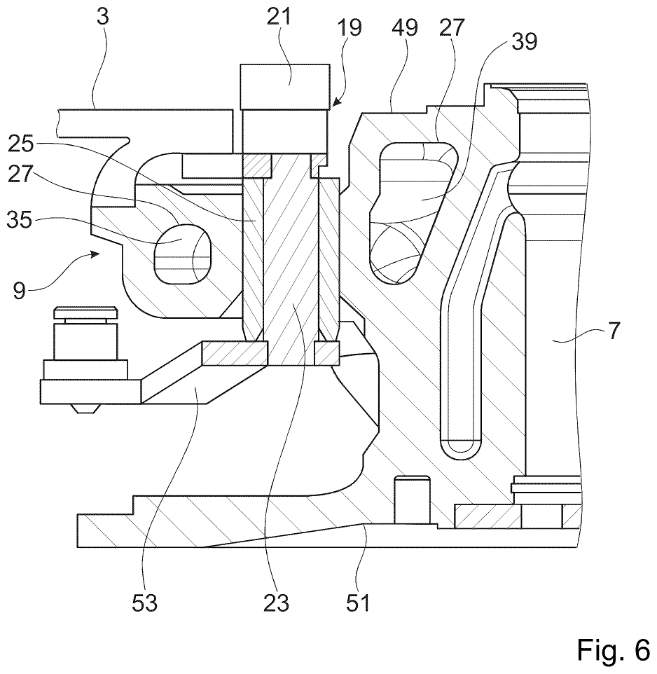

FIG. 6 shows a cross section of one exemplary embodiment of a bearing housing.

FIG. 1 shows a schematic illustration of a turbine 1 having a variable turbine geometry. It is a sectional illustration perpendicular to an axis of rotation. The turbine 1 is a part of an exhaust-gas turbocharger which also comprises a compressor.

The turbine 1 comprises a turbine housing 3 and a turbine wheel 5 which is located in the turbine housing 3. The function of the turbine housing 3 is to conduct the exhaust gas into the turbine wheel 5. A shaft 7 connects the turbine wheel 5 to a compressor wheel (not illustrated in FIG. 1), which is located in a compressor housing (not illustrated in FIG. 1), and thus transmits the rotation of the turbine wheel 5 to the compressor wheel. A bearing housing 9 (not illustrated in FIG. 1) is located between the turbine 1 and the compressor.

The turbine housing 3 comprises a volute 11 which serves to guide the inflowing gas around the turbine wheel 5. The spiral configuration of the volute 11 leads to the formation of a tongue 13 at the end of the volute 11, said tongue being located in the vicinity of an inlet portion 15. Located between the volute 11 and the turbine wheel 5 is a ring-like slot 17 through which the exhaust gas flows out of the volute 11 into the turbine wheel 5. A variable turbine geometry assembly 19 (VTG assembly) defines a base of the slot 17. The VTG assembly 19 comprises pivotable guide vanes 21 arranged in the slot 17. The angle of the guide vanes 21 relative to a radial direction can be changed, thus influencing the exhaust-gas flow from the volute 11 to the turbine wheel 5. A control shaft 23 facing away from the guide vanes 21 extends out of the VTG assembly 19. The guide vanes 21 are coupled to the control shaft 23 in such a way that a rotational movement of the control shaft 23 is transformed into a pivoting movement of the guide vanes 21, thus setting the angle of the guide vanes 21 in relation to their radial directions. The position of the control shaft 23 is marked by a dashed line.

The turbine 1 is coupled to the bearing housing 9, which is located below the VTG assembly 19. The control shaft 23 runs through a VTG bushing 25 in the bearing housing 9. Owing to the temperature of the hot exhaust gases, most temperature-induced stresses occur in the inlet portion 15 of the volute 11.

FIG. 2 shows a schematic cross-sectional view of a conventional bearing housing 9 comprising a coolant jacket 27 within the bearing housing 9. The conventional coolant jacket 27, which is defined by a cavity enclosed in the wall of the bearing housing 9, is illustrated in FIG. 3. The coolant jacket 27 comprises an inlet 29 and an outlet 31 which have tubular shapes. The coolant jacket 27 encloses the shaft 7 which passes through the bearing housing 9 along the longitudinal axis 33 of the bearing housing 9. Between the inlet 29 and the outlet 31, the coolant jacket 27 forms two flow paths on the two sides of the shaft 7. The VTG bushing 25 is located outside the coolant jacket 27. The cross section of the coolant jacket 27 has a ring-like basic shape between the inlet 29 and the outlet 31. The ring shape tapers in the region between the shaft 7 and the control shaft 23, in order to accommodate the VTG bushing 25.

The narrowing reduces the cooling effect in the region of the VTG bushing 25, which can lead to the occurrence of cracks in this region. This effect is also intensified if the VTG bushing 25 is located in the vicinity of the inlet portion 15 of the volute 11 or in the vicinity of the tongue 13. The combination of a hot, inflowing exhaust-gas flow over a bearing housing region with less cooling considerably increases the risk of crack formation.

The temperature lines 57 and 55 illustrate the expansion of the regions with the greatest thermomechanical stress in an edge region into which the hot exhaust gas flows. Between the lines 57 and 55, the stress is somewhat lower than outside the line 57.

FIG. 4 shows a schematic cross-sectional view of the bearing housing 9 in which a coolant jacket 27 according to the invention is accommodated. The walls of the coolant jacket 27, which are defined by a cavity in the bearing housing 9, are illustrated in FIG. 5.

The coolant jacket 27 comprises an inlet 29 and an outlet 31 which are tubular. The coolant jacket 27 encloses not only the shaft 7 but also the VTG bushing 25 through which the control shaft 23 runs. The coolant jacket 27 comprises, inter alia, two flow paths on the two sides of the shaft 7. A central flow path 39 is located between the longitudinal axis 33 and the VTG bushing 25. The peripheral flow paths 37, 35 are located on the sides of the longitudinal axis 33 and of the VTG bushing 25 which face away from one another.

A cross section of the cooling jacket 27 perpendicular to the longitudinal axis 33 has an outer contour line 41 which has, in the region of the VTG bushing 25, a radial widening 47 and thus encloses the VTG bushing 25. The outer contour line 41 is a continuous curve which has a circular basic shape with a bell-like radial widening 47. A first inner contour line 43 encloses the longitudinal axis 33, more specifically an opening for the shaft 7, whilst a second inner contour line 45 encloses the VTG bushing 25. The second inner contour line 45 is circular. Thus, the coolant jacket 27 is divided into three flow paths: one central one and two peripheral ones. These flow paths 39, 35, 37 lead the cooling water around the shaft 7 and the VTG bushing 25.

The coolant jacket 27 has a widened periphery in the vicinity of the VTG bushing 25. Such a configuration serves to cool both the VTG bushing 25 and the inlet portion 15 of the volute 11. The design of the cooling system prevents the occurrence of temperature-induced stresses in the region of the VTG bushing 25 and thus obviates the formation of cracks.

FIG. 6 shows a cross section through the bearing housing 9 along the longitudinal axis 33, illustrating half of the component.

The bearing housing 9 comprises a turbine side 49, which is oriented towards the turbine 1, and an opposite compressor side 51, which is oriented towards the compressor. The bearing housing 9 connects the turbine housing 3 and the compressor housing. The bearing housing 9 serves to bear the mechanical loading of the rotating components and to withstand and dissipate the heat loading by a turbine side. The turbine side 49 of the bearing housing 9 is formed into a flange which widens in the direction of the volute 11 and is connected to the turbine housing 3. The VTG bushing 25 is located within the bearing housing 9, below the VTG assembly 19. The VTG bushing 25 is pressed into the housing in such a way that it cannot move or detach. In this embodiment, the longitudinal axis 33 and the VTG bushing 25 run parallel to one another.

The control shaft 23 is coupled to the VTG assembly 19 and projects through the VTG bushing 25 out of the bearing housing 9. A lever 53 is connected to the control shaft 23 outside the bearing housing 9. The lever 53 runs in the radial direction with respect to the control shaft 23, and a rotational movement of the lever 53 brings about a rotational movement of the control shaft 23 and thus an adjustment of the guide vanes 21.

The coolant jacket 27 comprises a central flow path 39 which runs between the shaft 7 along the longitudinal axis 33 and the VTG bushing 25. The central flow path 39 is located below the turbine wheel 5. A peripheral flow path 35 is located on the peripheral side of the VTG bushing 25, below the VTG assembly 19 and/or the volute 11. Consequently, the VTG bushing 25 and the shaft 7 are surrounded by the cooling jacket 27.

The central flow path 39, which is located between the longitudinal axis 33 and the VTG bushing 25, extends further in the axial direction with respect to the turbine housing 3 than the peripheral flow path 35, which runs around the VTG bushing 25 in the radial widening 47.

The features specified above and in the claims and shown in the figures can be advantageously implemented both individually and in various combinations. The invention is not restricted to the exemplary embodiments described, but may be modified in various ways within the scope of the abilities of a person skilled in the art.

### REFERENCE SIGNS

1 Turbine
3 Turbine housing
5 Turbine wheel
7 Shaft
9 Bearing housing
11 Volute
13 Tongue
15 Inlet portion
17 Slot
19 VTG assembly
21 Guide vane
23 Control shaft
25 VTG bushing
27 Coolant jacket
29 Inlet
31 Outlet
33 Longitudinal axis
35, 37 Peripheral flow path
39 Central flow path
41 Outer contour line
43 First inner contour line
45 Second inner contour line
47 Widening
49 Turbine side
51 Compressor side
53 Lever
55, 57 Temperature line

1. A turbocharger housing for a turbine (1) having a variable turbine geometry which can be adjusted by a control shaft (23), comprising
a turbine housing (3),
a bearing housing (9) having a longitudinal axis (33) and having a VTG bushing (25) for the control shaft (23), wherein the VTG bushing (25) is spaced apart from the longitudinal axis (33),
wherein the bearing housing (9) comprises a coolant jacket (27) which comprises an inlet (29) and an outlet (31), wherein the coolant jacket (27) encloses the VTG bushing (25).

2. The turbocharger housing according to claim 1,
wherein the coolant jacket (27) also encloses the longitudinal axis (33) and comprises a central flow path (39) between the longitudinal axis (33) and the VTG bushing (25).

3. The turbocharger housing according to claim 1,
wherein a cross section of the coolant jacket (27) comprises
an outer contour line (41) having a radial widening (47) which encloses the VTG bushing (25),
a first inner contour line (43) which encloses the longitudinal axis (33), and
a second inner contour line (45) which encloses the VTG bushing (25).

4. The turbocharger housing according to claim 3,
wherein the outer contour line (41) is a continuous curve which has a circular basic shape with a bell-like radial widening (47), and/or wherein the second inner contour line (45) is a circular line.

5. The turbocharger housing according to claim 3,
wherein the central flow path (39) between the longitudinal axis (33) and the VTG bushing (25) extends further in the axial direction with respect to the turbine housing (3) than a peripheral flow path (35), which runs around the VTG bushing (25) in the radial widening (47).

6. The turbocharger housing according to claim 1,
wherein the longitudinal axis (33) and the VTG bushing (25) are arranged parallel to one another or at an acute angle relative to one another.

7. A turbocharger comprising
a turbine housing (3), a turbine wheel (5) arranged in the turbine housing (3), and a variable turbine geometry assembly (19) which can be adjusted by a control shaft (23),
a bearing housing (9) having a longitudinal axis (33) and having a VTG bushing (25) through which the control shaft (23) extends, wherein the VTG bushing (25) is spaced apart from the longitudinal axis (33),
wherein the bearing housing (9) comprises a coolant jacket (27) which comprises an inlet (29) and an outlet (31), wherein the coolant jacket (27) encloses the VTG bushing (25).

8. The turbocharger according to claim 7,
having a shaft (7) which extends through the bearing housing (9) along the longitudinal axis (33), wherein the shaft (7) is connected to the turbine wheel (5),
and wherein the coolant jacket (27) also encloses the shaft (7) and comprises a central flow path (39) between the shaft (7) and the VTG bushing (25).

9. The turbocharger according to claim 8,
wherein a cross section of the coolant jacket (27) comprises
an outer contour line (41) having a radial widening (47) which encloses the VTG bushing (25),
a first inner contour line (43) which encloses the shaft (7), and
a second inner contour line (45) which encloses the VTG bushing (25).

10. The turbocharger according to claim 9,
wherein the outer contour line (41) is a continuous curve which has a circular basic shape with a bell-like radial widening (47), and/or wherein the second inner contour line (45) is a circular line.

11. The turbocharger according to claim 9,
wherein the central flow path (39) between the shaft (7) and the VTG bushing (25) extends further in the axial direction with respect to the turbine housing (3) than a peripheral flow path (35), which runs around the VTG bushing (25) in the radial widening (47).

12. The turbocharger according to claim 8,
wherein the shaft (7) and the VTG bushing (25) are arranged parallel to one another or at an acute angle relative to one another.

13. The turbocharger according to claim 9,
wherein the turbine housing (3) comprises a volute (11) for the inflow of gas, comprising an inlet portion (15) and a tongue (13), wherein the radial widening (47) is oriented onto the inlet portion (15) or the tongue (13).
